(19) United States
(12) Patent Application Publication
(10) Pub. No.: US 2016/0131167 A1
(43) Pub. Date: May 12, 2016

(54) MOTION DETECTION DEVICE

(71) Applicant: SEIKO EPSON CORPORATION, Tokyo (JP)

(72) Inventor: Tsutomu TANIGUCHI, Matsumoto-shi (JP)

(21) Appl. No.: 14/933,347

(22) Filed: Nov. 5, 2015

(30) Foreign Application Priority Data
Nov. 12, 2014 (JP) 2014-229987

(51) Int. Cl. F16B 2/22; F16M 13/02; A63B 24/00

(52) U.S. Cl. CPC F16B 2/22; A63B 24/0003; F16M 13/022

(57) ABSTRACT

A motion detection device includes a sensor that detects a motion and a holding tool that is used in order to mount the sensor to a sports equipment. The holding tool includes a curved plate whose one end is open, and whose inner surface is mounted on the sports equipment. The curved plate has multiple restraint portions which come into contact with the sports equipment by the inner surface being fastened to the sports equipment when the curved plate is mounted on and fastened to the sports equipment, and a discontinuous portion which is disposed between the multiple restraint portions and which causes the inner surface to function as a discontinuous surface by disposing at least any one of a concave portion and a convex portion therebetween.

### BACKGROUND

1. Technical Field

The present invention relates to a motion detection device.

2. Related Art

An analyzing method based on an image captured by a camera is known as a technique for analyzing and evaluating movements caused by swings of golf clubs, baseball bats, tennis racquets, and human bodies which use a sports equipment thereof. The analysis using the image is limited in terms of accuracy. Accordingly, attempts to perform more accurate motion analysis have been made by using acceleration sensors or gyro sensors. For example, JP-A-11-169499 discloses a swing analysis device in which a sensor capable of measuring acceleration in three directions is attached to a grip of a golf club so as to analyze a swing.

A method of attaching a sensor to a sports equipment includes various techniques. For example, the device disclosed in JP-A-11-169499 employs a tool (holding tool) for attaching a sensor which is a so-called attachment. Since attaching the sensor unpreferably increases the weight of the sports equipment, weight reduction using a plastic tool has been promoted in many cases.

In order to detect acceleration or angular speed of a motion of the sports equipment, this sensor is firmly fastened and fixed to the sports equipment so that dropping, misalignment, or rotating does not occur. However, if a strong impact is unexpectedly applied to a tool in a state where a portion of an inner side surface (surface in contact with the sports equipment) of the tool is fixed to the sports equipment while being uniformly and strongly pressed against the sports equipment, there is a possibility that a crack may appear near a boundary between a pressed portion and a non-pressed portion. Although this phenomenon occurs in only a special situation such as an unexpected impact, in order to ensure higher reliability, it is desirable that the crack is less likely to appear even in the special situation.

### SUMMARY

An advantage of some aspects of the invention is to provide a motion detection device which detects a motion by mounting a sensor on a sports equipment, and in which a holding tool is less likely to be damaged due to an impact in a state of being mounted thereon.

The invention can be implemented as the following forms or application examples.

### APPLICATION EXAMPLE 1

A motion detection device according to this application example includes a sensor that detects a motion and a holding tool that is used in order to mount the sensor on a sports equipment. The holding tool includes a curved plate whose one end is open, and whose inner surface is mounted on the sports equipment. The curved plate has multiple restraint portions which come into contact with the sports equipment by the inner surface being fastened to the sports equipment when the curved plate is mounted on and fastened to the sports equipment, and a discontinuous portion which is disposed between the multiple restraint portions and which causes the inner surface to function as a discontinuous surface by disposing at least any one of a concave portion and a convex portion therebetween.

The inner surface of this motion detection device has the multiple restraint portions which come into contact with the sports equipment by the inner surface being fastened to the sports equipment, and the discontinuous portion which causes the inner surface to function as the discontinuous surface by disposing at least any one of the concave portion and the convex portion therebetween. Accordingly, when an external force is applied in a state where the motion detection device is mounted on the sports equipment, stress is dispersed, and stress concentration is relaxed. In this manner, the motion detection device in which dropping, misalignment, and rotating are less likely to occur can be stably mounted on the sports equipment. Even if an impact is applied to the motion detection device in a mounted state, the holding tool is less likely to be damaged.

### APPLICATION EXAMPLE 2

In the motion detection device according to Application Example 1, when the curved plate is mounted on and fastened to the sports equipment, a non-contact portion in which the inner surface of the curved plate does not come into contact with the sports equipment may be formed in the curved plate.

In this motion detection device, the non-contact portion is formed between the multiple restraint portions, and the discontinuous portion which causes the inner surface to function as the discontinuous surface is provided.

Accordingly, when an external force is applied in a state where the motion detection device is mounted on the sports equipment, stress is further dispersed, and stress concentration on the vicinity of the restraint portions is further relaxed.

### APPLICATION EXAMPLE 3

In the motion detection device according to Application Example 1 or 2, the discontinuous portion may be configured to include an elastic member which is disposed on the inner surface of the curved plate.

In this motion detection device, the discontinuous portion is formed of the elastic member having a restoring force. Accordingly, the motion detection device is easily and more firmly mounted on the sports equipment.

### APPLICATION EXAMPLE 4

A motion detection device according to this application example includes a sensor that detects a motion and a holding tool that is used in order to mount the sensor on a sports equipment. The holding tool includes a curved plate whose one end is open, and whose inner surface is mounted on the sports equipment. The curved plate includes multiple restraint portions which come into contact with the sports equipment by the inner surface being fastened to the sports equipment when the curved plate is mounted on and fastened to the sports equipment, and has a portion in which the inner surface does not extend along an outer shape of the sports equipment.

This motion detection device includes the multiple restraint portions which come into contact with the sports equipment by the inner surface being fastened to the sports equipment when the motion detection device is mounted on and fastened to the sports equipment, and has the portion in which the inner surface does not extend along the outer shape of the sports equipment. Accordingly, when an external force is applied in a state where the motion detection device is mounted on the sports equipment, stress is dispersed, and stress concentration is relaxed. In this manner, the motion detection device in which dropping, misalignment, and rotating are less likely to occur can be stably mounted on the sports equipment. Even if an impact is applied to the motion detection device in a mounted state, the holding tool is less likely to be damaged.

### APPLICATION EXAMPLE 5

In the motion detection device according to any one of Application Examples 1 to 4, the curved plate may be fitted to the sensor, in the one end.

According to this motion detection device, the sensor in which dropping, misalignment, and rotating are less likely to occur can be stably and more easily mounted on the sports equipment. Even if an impact is applied to the motion detection device in a mounted state, the motion detection device is less likely to be damaged.

### BRIEF DESCRIPTION OF THE DRAWINGS

The invention will be described with reference to the accompanying drawings, wherein like numbers reference like elements.

FIG. 1 is an external perspective view illustrating a state where a holding tool according to an embodiment is mounted on a sports equipment (golf club).

FIG. 2 is an enlarged view illustrating a range indicated by A in FIG. 1, and is a schematic view illustrating a process where a sensor is fitted to the holding tool according to the embodiment.

FIG. 3 is an enlarged view illustrating the range indicated by A in FIG. 1, and is a schematic view illustrating a sensor-installed sports equipment in a state where the holding tool according to the embodiment has been mounted on the sports equipment and the sensor has been fitted to the holding tool.

FIG. 4 is a perspective view of the holding tool according to the embodiment, and is a perspective view when viewed in a direction of an arrow indicated by J in FIG. 12.

FIGS. 5A to 5D are schematic views illustrating some examples of a cross section of the holding tool according to the embodiment, and correspond to a cross section P illustrated in FIG. 4.

FIG. 6 is a schematic view when the sensor according to the embodiment is planarly viewed from an upper surface thereof.

FIG. 7 is a schematic view when the sensor according to the embodiment is planarly viewed from a lower surface thereof.

FIG. 8 is a schematic view when the sensor according to the embodiment is viewed in a direction of an arrow indicated by F in FIG. 6.

FIG. 9 is a schematic view illustrating a cross section in which the sensor according to the embodiment is cut away along line B-B′ in FIGS. 6 and 7.

FIG. 10 is a schematic view illustrating a cross section in which the sensor according to the embodiment is cut away along line C-C′ in FIG. 7 and line E-E′ in FIG. 8.

FIG. 11 is a schematic view when the holding tool according to the embodiment is planarly viewed from a mounting surface side thereof.

FIG. 12 is a schematic view when the holding tool according to the embodiment is viewed in a direction of an arrow indicated by G in FIG. 11.

FIG. 13 is a schematic view when the holding tool according to the embodiment is viewed in a direction of an arrow indicated by H in FIG. 11.

FIG. 14 is a schematic view illustrating a cross section in a state where the holding tool according to the embodiment is mounted on the sports equipment (golf club).

FIG. 15 is a schematic view illustrating a cross section in a state where the sensor is fitted to the holding tool according to the embodiment.

FIG. 16 is an enlarged view illustrating a range indicated by J in FIG. 15.

FIG. 17 is a schematic view illustrating a cross section taken along line L-L′ in FIG. 16.

FIG. 18 is a schematic view illustrating a cross section taken along line M-M′ in FIG. 17.

FIG. 19 is a schematically enlarged view illustrating an operation state of a pressing projection.

FIGS. 20A to 20D are schematic views illustrating some examples of an external shape of a direction indicator in the sensor.

FIG. 21 is a schematic view illustrating a cross section in a state where a holding tool in the related art is mounted on a golf club.

FIG. 22 is an external view illustrating a sensor-installed sports equipment and a motion analysis device according to the embodiment.

FIG. 23 is a block diagram illustrating the motion analysis device according to the embodiment.

### DESCRIPTION OF EXEMPLARY EMBODIMENTS

Hereinafter, some embodiments according to the invention will be described. The embodiments described below are intended to describe an example of the invention. Without being limited to the following embodiments at all, the invention includes various modification examples which are embodied within the scope not changing the gist of the invention. All configurations described below are not necessarily indispensable configurations of the invention.

### 1. Motion Detection Device

A motion detection device according to the present embodiment includes a sensor that detects a motion and a holding tool that is used in order to mount the sensor on a sports equipment.

### 1.1 Sports Equipment

The sports equipment on which the motion detection device according to the embodiment is mounted has a clasp-available shape such as a rod shape, a columnar shape, and a cylindrical shape. As long as the sports equipment performs movement (spatial position movement, a change in shapes or postures, rotations, and vibrations), the shape is not limited thereto. This sports equipment includes equipment used in various athletic sports, for example, golf clubs, baseball bats, tennis racquets, and bamboo swords for Kendo. In addition to the equipment, the sports equipment can further include an exercising arm, a portion of a human body such as a foot, or a movable unit such as an arm of a robot device, in response to a swing of the sports equipment.

Hereinafter, a case where the sports equipment is a golf club will be described. Although no particular limitation is imposed on the golf club, a case where a shaft of the golf club has a rubber grip attached thereto will be described. In this description, an aspect will be described in which the holding tool of the motion detection device according to the embodiment clasps a portion of the rubber grip. However, the shaft may be clasped, or a boundary portion therebetween may be clasped.

### 1.2 Holding Tool

The holding tool includes a curved plate whose one end is open and whose inner surface is mounted on the sports equipment. The curved plate has multiple restraint portions which come into contact with the sports equipment by the inner surface being fastened to the sports equipment when the curved plate is mounted on and fastened to the sports equipment, and a discontinuous portion which is disposed between the multiple restraint portions and which causes the inner surface to function as a discontinuous surface by disposing at least any one of a concave portion and a convex portion therebetween. In other words, the holding tool includes the curved plate which has the restraint portions and which clasps an object in the restraint portions, and includes a contact portion which is disposed in the curved plate. The holding tool is a tool or an attachment used in order to mount a sensor (to be described later) on the object.

### 1.2.1 Curved Plate

A holding tool 20 according to the embodiment includes a curved plate 21 which has a restraint portion 21a and which clasps a golf club 200 (object) in the restraint portion 21a. The curved plate 21 partially or entirely configures the holding tool 20. In the embodiment, an example will be described where the curved plate 21 entirely configures the holding tool 20. That is, in the embodiment, the curved plate 21 functions as the holding tool 20. The holding tool 20 may be configured to include the curved plate 21 and another member (for example, mechanism for fixing a sensor 10).

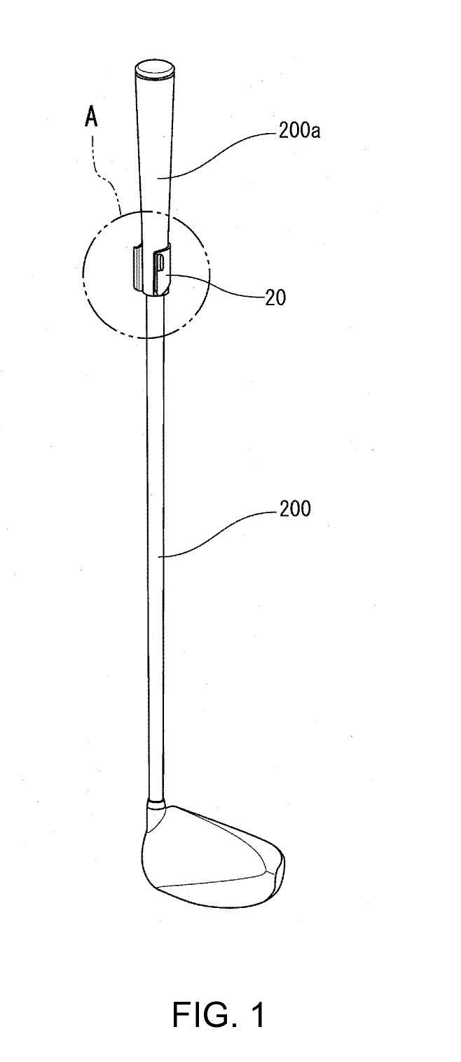

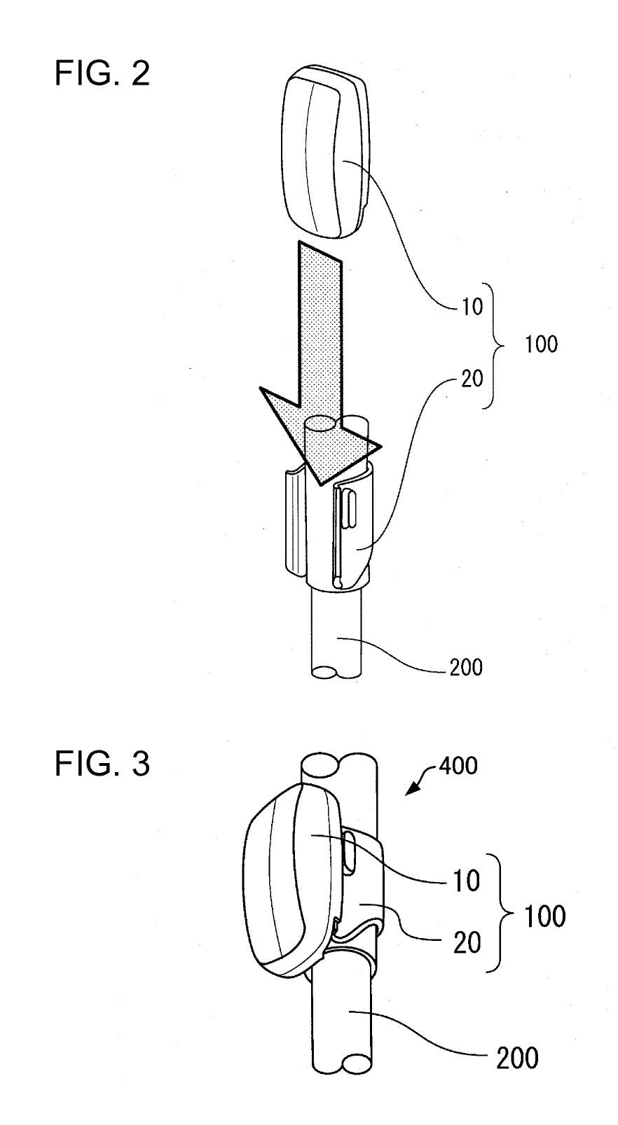

FIG. 1 is an external perspective view illustrating a state where the holding tool 20 according to the embodiment is mounted on the golf club 200 (sports equipment). FIG. 2 is an enlarged view illustrating a range indicated by A in FIG. 1, and is a schematic view illustrating a process where the sensor 10 is fitted to the holding tool 20 according to the embodiment. FIG. 3 is an enlarged view illustrating the range indicated by A in FIG. 1, and is a schematic view illustrating a state where the sensor 10 is fitted to the holding tool 20 according to the embodiment.

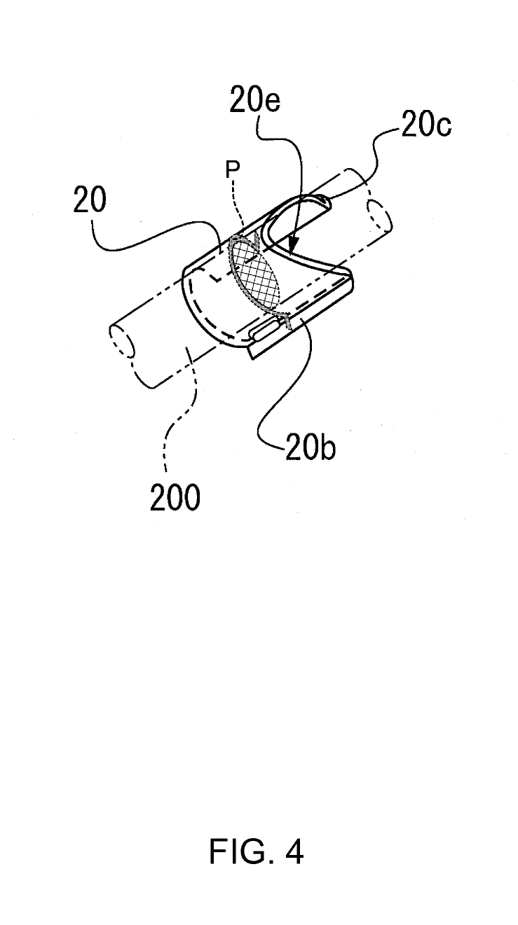

As illustrated in FIG. 1, the sensor 10 internally including a sensor portion 13 such as an inertial sensor (not illustrated) is mounted on the holding tool 20 which can be mounted on a grip portion 200a of the golf club 200 via fitting portions 20b and 20c illustrated in FIG. 4, in a direction of an arrow illustrated in FIG. 2. As illustrated in FIG. 3, the sensor 10 is mounted on the golf club 200.

As illustrated in FIG. 3, a motion detection device 100 (including the holding tool 20 and the sensor 10 fitted to the holding tool 20) according to the embodiment is mounted on the golf club 200 functioning as an exercising object. That is, when the holding tool 20 is mounted on the golf club 200 and the fitting portions 20b and 20c are fitted to the sensor 10, the sensor 10 is mounted on the golf club 200 so as to surround the golf club 200.

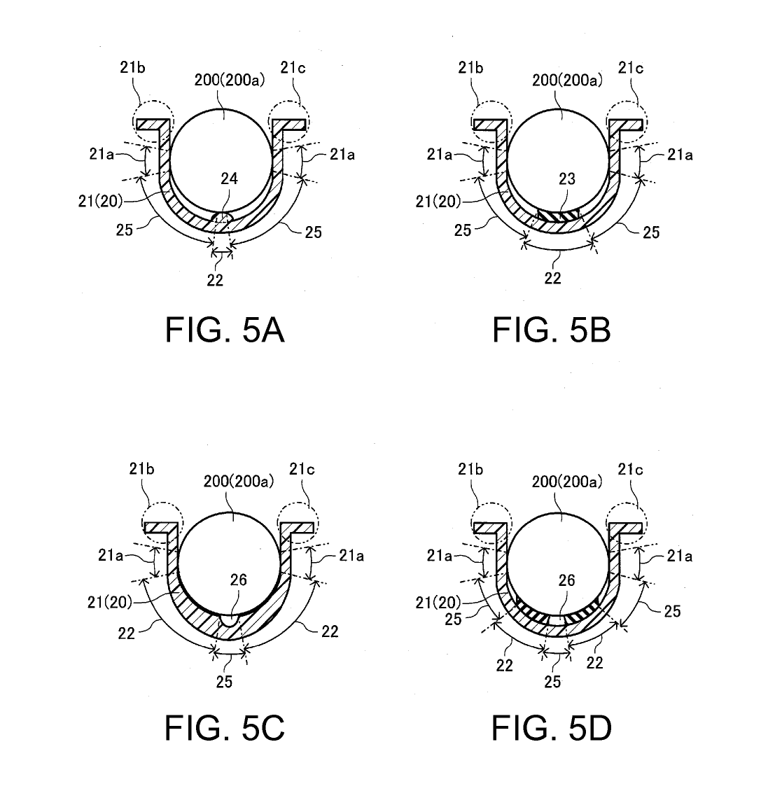

The holding tool 20 (curved plate 21) has a restraint portion 21a, and clasps an object in the restraint portion 21a (refer to FIGS. 5A to 5D). In the description herein, the meaning of “the curved plate clasps the object” indicates that the curved plate is mounted on and fixed to (held by) the object having a rod shape, a columnar shape, or a cylindrical shape so as to clasp (grasp, clutch, or grip) the object. The meaning may indicate a state where the curved plate is fixed to (held by) the object by covering at least a half peripheral portion of the object without covering the entire periphery. In other words, this aspect can be described by the meanings of “the curved plate seizes the object” and “the curved plate is attached to the object by seizing the object”.

A material of the curved plate 21 is not particularly limited as long as a force (grip strength) for clasping the golf club 200 can be obtained. For example, if polyethylene, polypropylene, polystyrene, polyvinyl chloride, polycarbonate, ABS resin, fluororesin, acrylic resin, or synthetic resin such as a copolymer of these materials is used, the material can contribute to weight reduction of the curved plate 21.

### 1.2.2 Restraint Portion

The restraint portion 21a is formed on an inner side in a curved shape of the curved plate 21 (holding tool 20). FIG. 4 is a perspective view of the curved plate 21 (holding tool 20) (referring to FIG. 12, a viewing direction is a direction of an arrow indicated by J). FIGS. 5A to 5D are schematic views illustrating some aspects of a cross section taken in a state where the holding tool 20 according to the embodiment is mounted on the golf club 200, and correspond to a cross section P illustrated in FIG. 4. A position of the cross section P illustrated in FIG. 4 is near the center of the holding tool 20 in an extending direction of the golf club 200. However, the position of the cross section P in the holding tool 20 is not particularly limited as long as the cross section in which the holding tool 20 is illustrated as a single member as illustrated in FIGS. 5A to 5D can be obtained at the position.

As illustrated in examples of FIGS. 5A to 5D, the restraint portion 21a is a portion of the curved plate 21 which presses (fastens) and pinches the golf club 200. In a state where the curved plate 21 is not mounted on the golf club 200, an inner side space of the curved plate 21 is smaller than an outer shape of the golf club 200. Therefore, in a state where the curved plate 21 is mounted on the golf club 200, a restoring force (biasing force) of the curved plate 21 brings the curved plate 21 in a state of fastening (pinching) the golf club 200. The restraint portion 21a is a portion which is restrained and pressed against the golf club 200 by the restoring force being converted into a pressing force. That is, when the curved plate (holding tool 20) is mounted on the golf club 200, the restraint portion 21a is a portion which comes into contact (pressing contact) with the golf club 200 while pressurizing the golf club 200.

As illustrated in FIGS. 5A to 5D, the restraint portion 21a is formed at two positions which enable the golf club 200 to be pinched therebetween. The restraint portion 21a may be formed at three or more positions. All portions in which the curved plate 21 and the golf club 200 are in contact with each other may not be the restraint portion 21a. The multiple restraint portions 21a are arranged separate from each other on an inner side surface (mounting surface 20a) of the curved plate 21. In other words, a contact surface formed by the restraint portion 21a is discontinuous in a direction in which the curved plate 21 turns around the golf club 200.

In each cutting plane illustrated in FIGS. 5A to 5D, the restraint portion 21a may be formed to extend up to an end portion of the curved plate 21, or may be formed to avoid the end portion of the curved plate 21. In the examples of FIGS. 5A to 5D, since fitting portions 21b and 21c are formed in the end portion of the curved plate 21, the restraint portion 21a is formed to avoid the end portion of the curved plate 21. The fitting portions 21b and 21c formed in the curved plate 21 can be respectively regarded as the fitting portions 20b and 20c disposed in the holding tool 20.

Furthermore, in other words, as illustrated by each cutting plane illustrated in FIGS. 5A to 5D, the two restraint portions 21a are respectively formed in one end portion and the other end portion of the curved plate 21. If the curved plate 21 is traced along the inner side surface (mounting surface 20a) of the curved plate 21 so as to turn around an axis of the golf club 200, a portion which is not restrained is present between the two restraint portions 21a. The restraint portions 21a are discontinuously arranged, and a contact surface which is formed by the restraint portions 21a and which is in contact with the golf club 200 functions as a discontinuous surface.

In each cutting plane by which the curved plate 21 is cut away as illustrated in FIGS. 5A to 5D, another restraint portion 21a (not illustrated) may be formed on an inner side surface of the curved plate 21, between the two restraint portions 21a. Even in this case, the respective restraint portions 21a are formed to be discontinuous with each other on the mounting surface 20a.

In each cutting plane by which the curved plate 21 is cut away as illustrated in FIGS. 5A to 5D, a contact portion 22 is disposed on an inner side surface of the curved plate 21, between the two restraint portions 21a. According to the examples illustrated in FIGS. 5A, 5B, and 5D, the contact portion 22 is separated from the restraint portions 21a. However, the restraint portions 21a and the contact portion 22 may be continuous with each other. Alternatively, the multiple restraint portions 21a may be discontinuously arranged by the contact portion 22. In this case, as illustrated in FIG. 5C, the contact portion 22 may be arranged to be continuous with the restraint portion 21a, or a portion having a restraint force becomes the restraint portion 21a. Although the example of FIG. 5C illustrates the contact portion 22, when the contact portion 22 has the restraint force, the contact portion 22 becomes the restraint portion 21a. However, since a concave portion 26 (to be described later) is formed therein, the two restraint portions 21a are adapted to be separated from and discontinuous with each other.

Although not illustrated, a flexible material such as rubber may be arranged on a surface in which the restraint portions 21a are in contact with the golf club 200, or the surface may be subjected to slip preventing work.

The restraint portion 21a functions to prevent dropping, misalignment and rotating of the curved plate 21 when the curved plate 21 is mounted on the golf club 200.

### 1.2.3 Contact Portion

The curved plate 21 (holding tool 20) includes the contact portion 22. The contact portion 22 is formed between the curved plate 21 and the golf club 200, and comes into contact with the golf club 200. The contact portion 22 may come into contact with the golf club 200 while restraining the golf club 200. However, in this case, the contact portion 22 functions as the restraint portion 21a. Thus, the contact portion 22 is formed to be discontinuous with the other restraint portion 21a.

The contact portion 22 may be formed integrally with the curved plate 21, or may be formed separately. In the example of FIG. 5A, the contact portion 22 is a convex portion 24 formed in the curved plate 21. As illustrated in FIG. 5B, an elastic member 23 attached to the curved plate 21 forms the contact portion 22. As illustrated in FIG. 5C, the contact portion 22 may be arranged to be continuous with the restraint portion 21a. Furthermore, as illustrated in FIG. 5D, the contact portion 22 may be disposed at multiple locations. The elastic member 23 illustrated in FIG. 5B is formed on only an inner surface in the illustration. However, an outer surface of the curved plate 21 may be covered with the elastic member 23 via a side surface of the curved plate 21. According to this configuration, even when the holding tool 20 is damaged by a strong mechanical load applied due to an impact such as dropping, it is possible to prevent the sensor 10 from being detached by the scattered holding tool 20. A member for covering the outer surface of the curved plate 21 may be disposed separately from the elastic member 23.

When the curved plate 21 (holding tool 20) is mounted on the golf club 200, the contact portion 22 comes into contact with the golf club 200. As a function of the contact portion 22, the contact portion 22 further improves the function of the restraint portion 21a so as to prevent dropping, misalignment, and rotating of the curved plate 21, when the curved plate 21 is mounted on the golf club 200. Since the contact portion 22 is present, the curved plate 21 can be more stably mounted on the golf club 200. Since the contact portion is present, stress concentration around the restraint portion 21a can be relaxed, and entire stress can be dispersed by partially generating stress in the contact portion 22.

When the contact portion 22 is configured to include the convex portion 24, the contact portion 22 has a shape protruding toward the golf club 200 on a surface of the curved plate 21 which faces the golf club 200. A shape of the convex portion 24 is not particularly limited. The contact portion 22 may be formed by using the elastic member 23. As the elastic member 23, it is possible to use various types of rubber, elastomer, or plastic. A shape of the elastic member 23 is not particularly limited. The elastic member 23 may be formed integrally with the curved plate 21, or may be installed by adhering to the curved plate 21.

Even if the contact portion 22 is arranged between the two restraint portions 21a without any gap, respective surfaces on which the two restraint portions 21a are in contact with the golf club 200 are discontinuous surfaces, and function as a discontinuous portion. The discontinuous portion may be configured to include the elastic member 23 disposed on the inner surface of the curved plate 21.

### 1.2.4 Non-Contact Portion

The curved plate 21 may have a non-contact portion 25 which does not come into contact with the golf club 200 when the curved plate 21 is mounted on the golf club 200. That is, when the curved plate 21 is mounted and fastened to the golf club 200, the non-contact portion 25 in which the inner surface of the curved plate 21 does not come into contact with the golf club 200 may be formed therein. The non-contact portion 25 is disposed in the curved plate 21 between the two restraint portions 21a on a cutting plane cut as illustrated in FIGS. 5A to 5D. The non-contact portion 25 may be disposed so as to be adjacent to the restraint portion 21a, or may be disposed so as to be adjacent to the contact portion 22. Furthermore, the non-contact portion 25 may be a concave portion 26 formed on the inner side surface (mounting surface 20a) of the curved plate 21. The non-contact portion 25 may be formed between the contact portions 22. Alternatively, for example, as illustrated in FIG. 5D, the non-contact portion 25 may be formed between the two elastic members 23 which are attached to the curved plate 21. When the curved plate 21 (holding tool 20) is mounted on the golf club 200, the non-contact portion 25 is separated from the golf club 200.

If the non-contact portion 25 is provided, stress is likely to be generated around the non-contact portion 25. Accordingly, it is possible to relax stress concentration around the restraint portion 21a.

When a grip rubber 200c of the golf club 200 is relatively hard, the non-contact portion 25 is formed by mounting the curved plate 21 on the golf club 200. However, when the grip rubber 200c is soft, the non-contact portion 25 is not formed in some cases, since the grip rubber 200c is in close contact with the curved plate 21 when the curved plate 21 is mounted on the golf club 200. In this case, for example, the concave portion 26 fulfills the same function as the contact portion 22.

If the non-contact portion 25 is formed, when the curved plate 21 is mounted on the golf club 200, a shape of a surface of the curved plate 21 which faces the golf club 200 is different from a surface shape in a portion of the golf club 200 on which the curved plate 21 is mounted. In other words, when the curved plate 21 is mounted on and fastened to the golf club 200, the curved plate 21 includes the multiple restraint portions 21a which come into contact with the golf club 200 by the inner surface of the curved plate 21 being fastened thereto. Accordingly, a portion is present in which the inner surface does not extend along an outer shape of the golf club 200.

If the non-contact portion 25 is arranged between the two restraint portions 21a, the respective surfaces on which the two restraint portions 21a come into contact with the golf club 200 become the discontinuous surfaces. The discontinuous portion may be configured to include the elastic member 23 disposed on the inner surface of the curved plate 21.

### 1.2.5 Fitting Portion

The curved plate 21 may have the fitting portions 20b and 20c on a further distal end side from the restraint portion 21a. The further distal side from the restraint portion 21a means a further end portion side of the curved plate 21 from the two restraint portions 21a on a cutting plane cut as illustrated in FIGS. 5A to 5D.

For example, the fitting portions 20b and 20c may function as a configuration for being fitted to the sensor 10 (to be described later). According to these fitting portions 20b and 20c, the sensor 10 in which dropping, misalignment, and rotating are less likely to occur can be stably mounted on the golf club 200.

Details of the fitting portions 20b and 20c will be described later. When the curved plate 21 (holding tool 20) is mounted on the golf club 200 and the fitting portions 20b and 20c are fitted to the sensor 10, the sensor 10 and the holding tool 20 (motion detection device 100) are mounted on the golf club 200 so as to surround the golf club 200. Furthermore, when the fitting portions 20b and 20c are fitted to the sensor 10, a degree at which the restraint portion 21a restrains the golf club 200 may be increased. In this case, the sensor 10 in which dropping, misalignment, and rotating are less likely to occur can be more stably mounted on the golf club 200. Even if an impact is applied to the sensor 10 in a mounted state, the sensor 10 can be less likely to be damaged.

The embodiment adopts an aspect in which the fitting portions 20b and 20c are slidingly fitted to the sensor 10. However, without being limited thereto, the aspect is not particularly limited as long as the sensor 10 can be fixed to the golf club 200.

### 1.3 Sensor

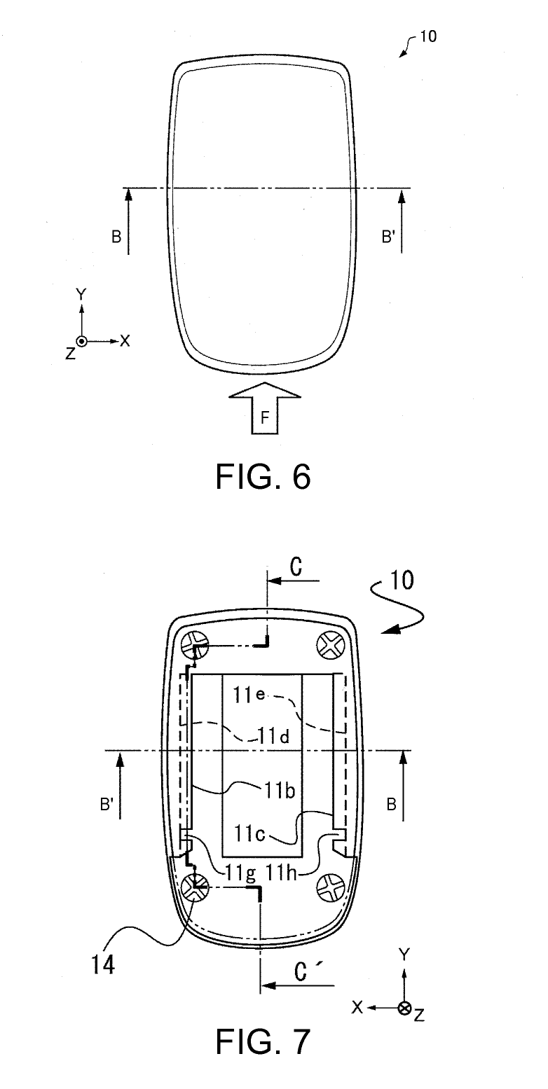

The sensor 10 will be described with reference to FIGS. 6 to 10. As illustrated in FIGS. 9 and 10, the sensor 10 configures a housing in which an internal space 10a is formed by a cover 12 fixed to a base 11 by a screw 14. On a surface 11a on the internal space 10a side of the base 11, a circuit board 13a which is the sensor portion 13 serving as a detector of the sensor 10 configured to include an electronic device 13b and the circuit board 13a having the electronic device 13b mounted thereon is fixedly attached to the surface 11a of the base 11 by means of adhesion. At least one electronic device 13b is an inertial sensor. The sensor portion 13 may include an acceleration sensor or an angular speed sensor. Furthermore, for example, the sensor portion 13 may be properly configured to be capable of analyzing a motion of three axes.

Means for fixing the cover 12 to the base 11 is not limited to the screw 14. For example, adhesion may be used, and fixing by means of welding can also be used if the base 11 and the cover 12 are formed of a plastic material.

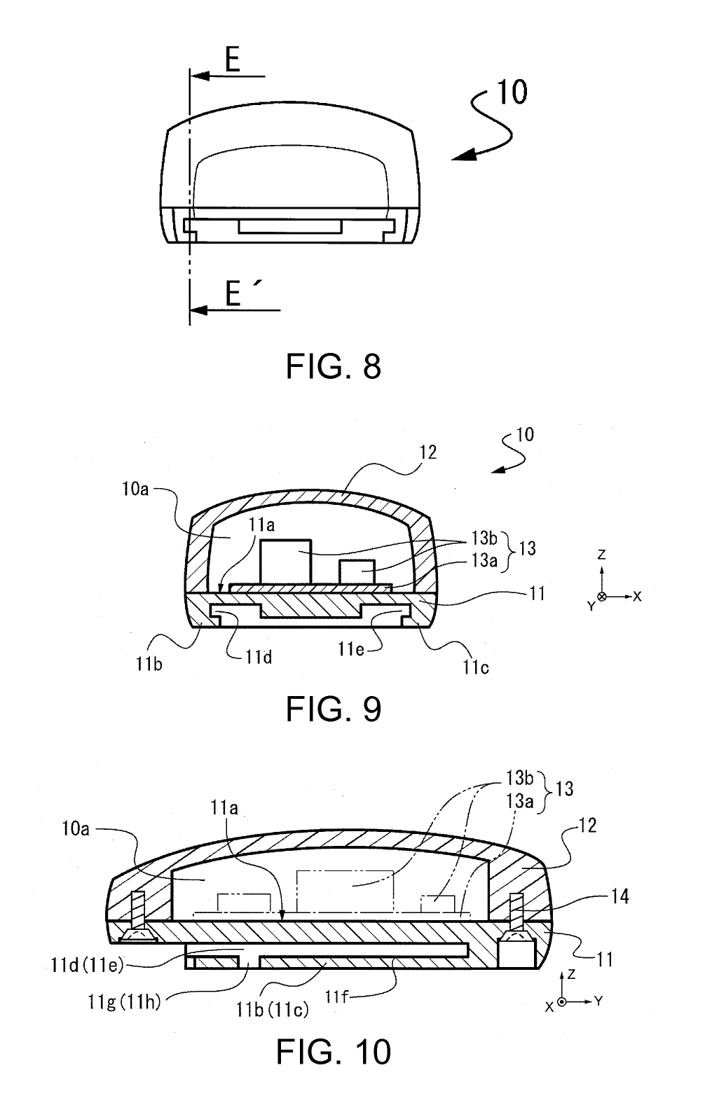

As illustrated in FIGS. 7 and 8, in the base 11, a first projection 11b and a second projection 11c extend in parallel with each other along a direction of the illustrated Y-axis. A first groove 11d serving as a recessed portion is formed in the first projection 11b along the direction of the Y-axis, and a second groove 11e serving as a recessed portion is also formed in the second projection 11c along the direction of the Y-axis. Openings of the first groove 11d and the second groove 11e in a direction of the X-axis are formed so as to face each other. The direction of the Y-axis (−) of the first groove 11d and the second groove 11e, that is, a side in an incorporating direction of the sensor 10 illustrated in FIG. 2 is open, and a groove wall 11f is formed in the opposite direction (refer to FIG. 9 together with FIG. 10). A cutout portion 11g is formed in the first projection 11b serving as an engagement portion for engaging with a disengagement preventing projection of the holding tool 20, and a cutout portion 11h is formed in the second projection 11c.

### 1.4 Fitting and Assembly

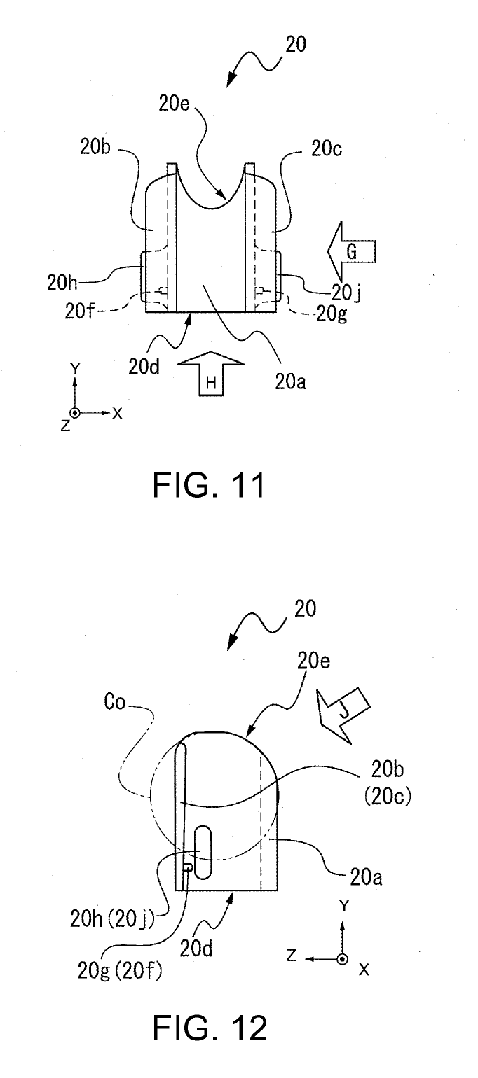

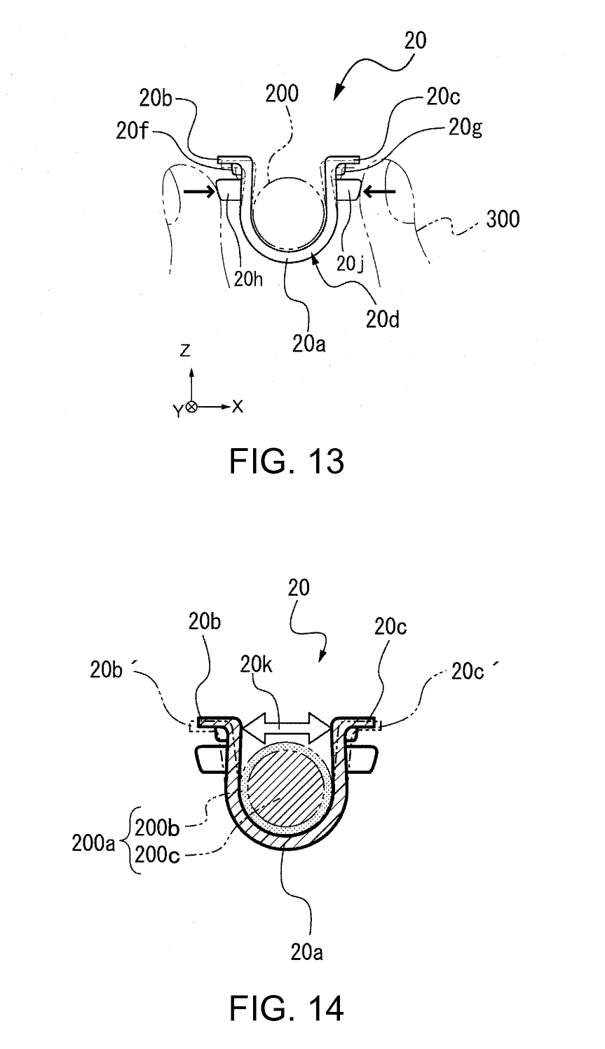

FIGS. 11 to 13 illustrate the holding tool 20. FIG. 11 is a plan view of the holding tool 20. FIG. 12 is a side view when the holding tool 20 is viewed in a direction of an arrow indicated by G in FIG. 11. FIG. 13 is a side view when the holding tool 20 is viewed in a direction of an arrow indicated by H in FIG. 11. FIGS. 11 to 13 illustrate the holding tool 20 by omitting the restraint portion 21a, the contact portion 22, and the non-contact portion 25.

As illustrated in FIG. 13, the holding tool 20 includes the mounting surface 20a which is mounted on the golf club 200 so as to be wound around the golf club 200 serving as an object, the fitting portion 20b serving as a projection-shaped portion which projects in the direction of the X-axis (−) in which the fitting portion 20b is inserted into the groove 11d of the sensor 10 illustrated in FIG. 2, and which extends in the direction of the Y-axis, and the fitting portion 20c serving as a projection-shaped portion which projects in the direction of the X-axis (+) in which the fitting portion 20c is inserted into the groove 11e, and which extends in the direction of the Y-axis.

As illustrated in FIG. 12, one end portion 20d of the holding tool 20 in the direction of the ±Y-axis is formed so as to extend along a plane X-Z, but the other end portion 20e intersects the plane X-Z. In this example, the other end portion 20e is formed in a shape extending along a large columnar plane Co. As a result, as illustrated in FIG. 11, a planar shape of the other end portion 20e is a concave shape. Since the other end portion 20e is formed in this way, one end portion 20d is allowed to have a clearly different shape. Therefore, for example, when the sensor 10 to be fitted to the holding tool 20 has a function by which the incorporating direction is designated, the holding tool 20 is mounted on the golf club 200 after aligning the other end portion 20e having a different shape with the golf club 200 as an indicator to indicate the incorporating direction. In this manner, it is possible to prevent the sensor 10 from being erroneously mounted thereon in the incorporating direction. The embodiment is not limited to a case where the other end portion 20e is allowed to have a shape which is different from that of one end portion 20d. The other end portion 20e may be provided with a simple marking.

The holding tool 20 may include disengagement preventing projections 20f and 20g of the sensor 10. The disengagement preventing projections 20f and 20g engage with an engagement portion (not illustrated) of the sensor 10 when the sensor 10 is incorporated therein (to be described later), thereby preventing the sensor 10 from disengaging from the holding tool 20. Since the disengagement preventing projections 20f and 20g are provided, there may be provided pressing projections 20h and 20j for disengaging the disengagement preventing projections 20f and 20g from the engagement portion of the sensor 10 when the sensor 10 is detached from the holding tool 20. When the sensor 10 is detached from the holding tool 20, the pressing projections 20h and 20j are pressed by a finger 300 in an arrow direction as illustrated in FIG. 13, and a distance between the disengagement preventing projections 20f and 20g is shortened. Then, the sensor 10 can be detached from the holding tool 20 by disengaging the disengagement preventing projections 20f and 20g from the engagement portion of the sensor 10.

Next, a state will be described where the sensor 10 is incorporated in the holding tool 20. FIG. 14 is a sectional view for describing a state where the holding tool 20 is mounted on the golf club 200. FIG. 14 illustrates the state by omitting the restraint portion 21a, the contact portion 22, and the non-contact portion 25.

As illustrated in FIG. 14, the holding tool 20 is mounted on the grip portion 200a of the golf club 200. The grip portion 200a has a configuration in which the grip rubber 200c for preventing slip is applied to or wound around a shaft portion 200b. For example, the grip rubber 200c is formed of an elastic material such as rubber and urethane elastomer. A repulsive force generated by the mounting surface 20a (inner surface of the curved plate 21) of the holding tool 20 compressing a portion between the grip rubber 200c and the shaft portion increases a frictional force between the holding tool 20 and the grip rubber 200c. In this manner, the holding tool 20 can be prevented from being misaligned with the golf club 200.

In the motion detection device 100 according to the embodiment, a form in which the holding tool 20 is mounted on the golf club 200 has been described as an example. However, for example, when the grip portion does not include means for preventing slip as in a baseball bat, an elastic member like the grip rubber 200c illustrated in FIG. 14 may be interposed between the baseball bat and the mounting surface 20a of the holding tool 20. A member for preventing slip which serves as a so-called interposed member may be arranged therein. As a material of the interposed member, it is preferable to use an elastic resin such as rubber and urethane elastomer, or soft metal.

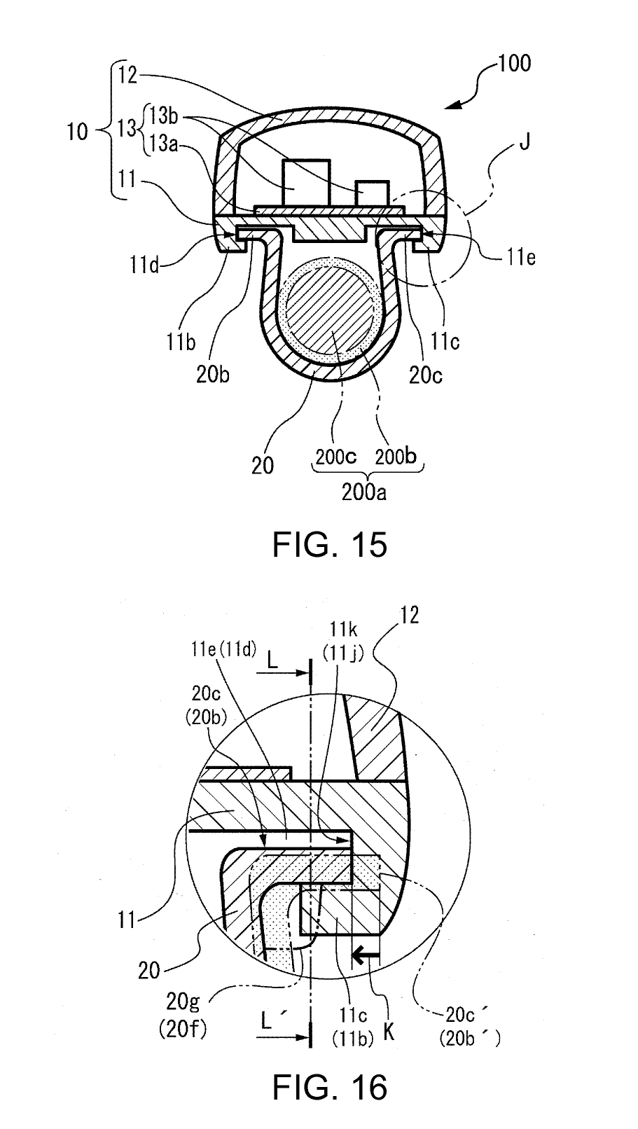

FIG. 15 is a sectional view when assembly is performed at a position corresponding to line B-B′ illustrated in FIG. 6, in a state where the holding tool 20 and the sensor 10 are assembled. FIG. 15 illustrates the state by omitting the restraint portion 21a, the contact portion 22, and the non-contact portion 25.

When the motion detection device 100 is assembled, as illustrated in FIG. 2, the sensor 10 is moved to the holding tool 20 mounted on the golf club 200 in the direction of the arrow. As illustrated in FIG. 15, the fitting portion 20b and the fitting portion 20c which are included in the holding tool 20 are respectively inserted into the groove 11d and the groove 11e which are formed in the sensor 10, by means of so-called sliding insertion. In this manner, the sensor 10 is mounted on the holding tool 20 mounted on the golf club 200, and is assembled to the motion detection device 100. That is, the curved plate 21 is fitted to the sensor 10 in an end in which the fitting portion 20b and the fitting portion 20c are disposed.

As illustrated in FIG. 14, if the holding tool 20 is mounted on the grip portion 200a of the golf club 200, the grip rubber 200c of the grip portion 200a is interposed between the mounting surface 20a of the holding tool 20 and the shaft portion 200b. In this state, due to the elasticity of the grip rubber 200c, a mounting opening 20k facing the mounting surface 20a is displaced and widened. The fitting portion 20b and the fitting portion 20c are brought into a state of a fitting portion 20b′ and a fitting portion 20c′ which are moved outward.

As illustrated in FIG. 15, the fitting portion 20b and the fitting portion 20c in the state of the fitting portion 20b′ and the fitting portion 20c′ are inserted into the groove 11d and the groove 11e, positions thereof are corrected in a direction of an illustrated arrow K by a groove wall surface 11j of the groove 11e and a groove wall surface 11k of the groove 11e as illustrated in FIG. 16. That is, in the state of the motion detection device 100 illustrated in FIG. 15, the position of the holding tool 20 is corrected in a direction in which the grip rubber 200c is compressed. In this manner, the holding tool 20 can improve a holding force for holding the grip portion 200a. In other words, the holding tool 20 is mounted on the golf club 200, and the sensor 10 is fitted to the holding tool 20, thereby fastening and fixing the holding tool 20. Therefore, the motion detection device 100 can be reliably aligned with the golf club 200, and thus the motion detection device 100 is less likely to be misaligned even when an inertial force or an impact force is applied to the motion detection device 100 by a swing of the golf club 200. Accordingly, proper swing data of the golf club 200 can be obtained.

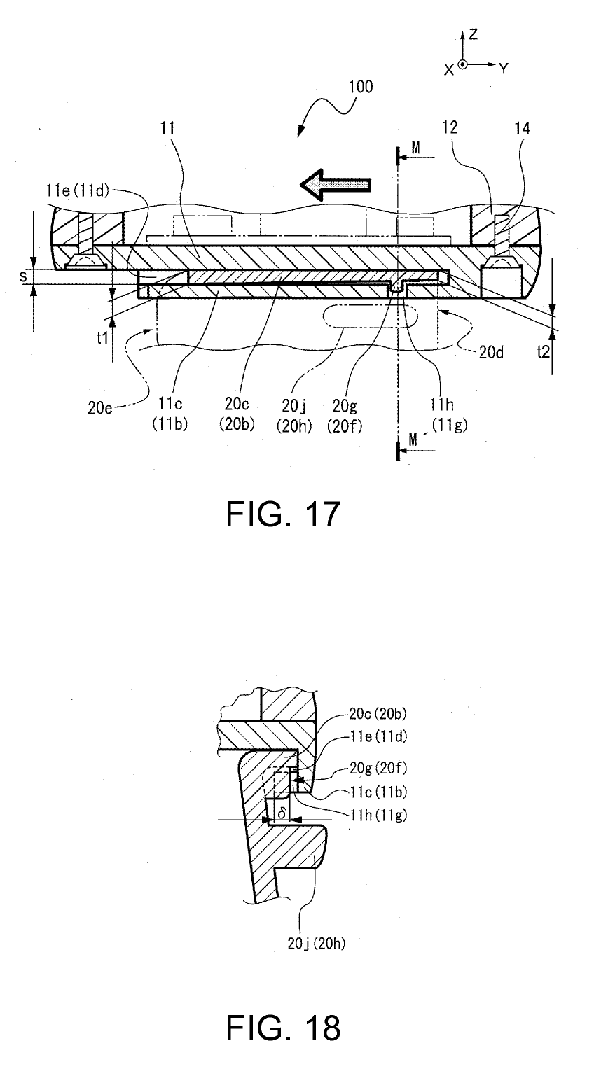

FIG. 17 is a schematic sectional view taken along line L-L′ in FIG. 16. As illustrated in FIG. 17, the sensor 10 is moved to the holding tool 20 in a direction of an illustrated arrow, and the fitting portion 20c of the holding tool 20 is relatively inserted into the groove 11e. Similarly, the fitting portion 20b of the holding tool 20 is relatively inserted into the groove 11d, and all of these are assembled to the motion detection device 100. The groove 11e and the fitting portion 20c correspond to the line L-L′ in FIG. 16. Accordingly, hereinafter, the groove 11e and the fitting portion 20c will be described as an example. The following description is similarly applied to the groove 11d and the fitting portion 20b.

When the sensor 10 is inserted into the holding tool 20 in the direction of the illustrated arrow, first, an end portion of the fitting portion 20c located on one end portion 20d side of the holding tool 20 starts to be inserted into the groove 11e. The fitting portion 20c is formed so that a thickness (direction of the Z-axis) t2 on one end portion 20d side and a height s of the groove 11e in the direction of the Z-axis satisfy t2<s. That is, the thickness of the fitting portion 20c on one end portion 20d side of the holding tool 20 is smaller than the groove height of the groove 11e. In this manner, the fitting portions can be easily incorporated therein when the insertion starts.

Furthermore, the fitting portion 20c is relatively inserted into the groove 11e, and as illustrated in FIG. 17, the disengagement preventing projection 20g of the holding tool 20 is fitted to the cutout portion 11h formed in the projection 11c, thereby completing the insertion. In this state, if a thickness t1 of the fitting portion 20c on the other end portion 20e side of the holding tool 20 is formed so as to satisfy a relationship of t1>t2, a gap between the groove 11e and the fitting portion 20c in the direction of the Z-axis is further narrowed on the other end portion 20e side, compared to one end portion 20d side in the holding tool 20. For example, under a condition of t1≅s or t1>s, the fitting portion 20c is brought into a state of being interposed between the surfaces of the groove 11e in the direction of the Z-axis. Accordingly, it is possible to prevent the sensor 10 from falling down from the holding tool 20. Since a backlash against the holding tool 20 in the direction of the Z-axis is suppressed for the sensor 10, proper swing data of the golf club 200 can be obtained.

FIG. 18 is a schematically enlarged sectional view taken along line M-M′ in FIG. 17. As illustrated in FIG. 18, in a state where the fitting portion 20c is inserted into the groove 11e, the disengagement preventing projection 20g engages with the cutout portion 11h of the projection 11c by an engagement amount 8 provided therebetween. This maintains a mounting state between the sensor 10 and the holding tool 20 as illustrated in FIG. 17.

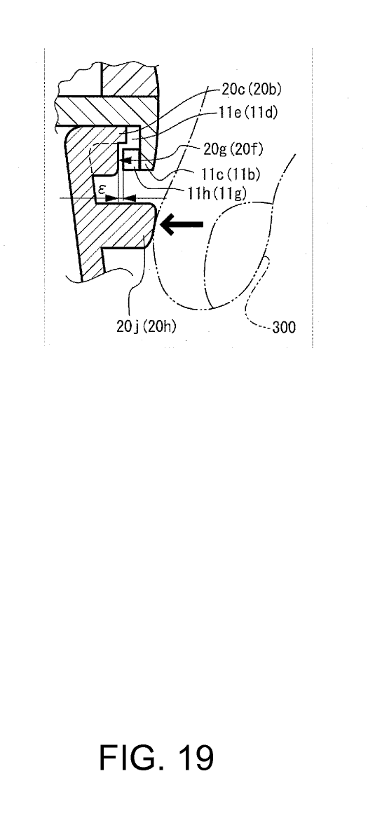

When the sensor 10 is detached from the holding tool 20 in this state, as illustrated in FIG. 19, the pressing projection 20j is pressed in a direction of an illustrated arrow by the finger 300, for example. In this manner, the disengagement preventing projection 20g is separated from the cutout portion 11h, and in a state where a gap ε (ε>0) is generated, the sensor 10 is slid in a direction opposite to an arrow illustrated in FIG. 17, thereby enabling the sensor 10 to be detached from the holding tool 20. As described above, the disengagement preventing projections 20g and 20f, and the cutout portions 11h and 11g to which the disengagement preventing projections 20g and 20f can be fitted are provided therein. Accordingly, while capability of mounting the sensor 10 on the holding tool 20 is ensured, the sensor 10 can be easily detached from the holding tool 20 when necessary.

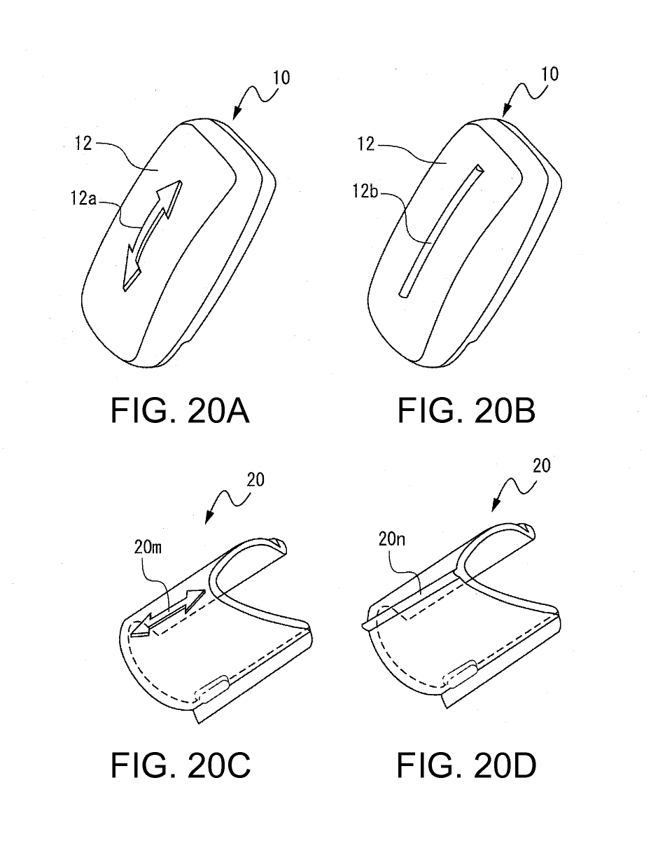

If the electronic device 13b included in the motion detection device 100 includes an inertial sensor provided with a detection axis, when the motion detection device 100 is mounted on the golf club 200, the detection axis of the inertial sensor needs to be relatively aligned with the golf club 200. In this case, as means for clearly indicating a direction of the detection axis, the motion detection device 100 may be provided with a direction indicator of the detection axis as illustrated in FIGS. 20A to 20D.

A form in which any one of direction indicators 12a, 12b, 20m, and 20n having a projection shape is formed integrally is described as an example. However, without being limited thereto, both of them may have a concave shape formed by means of molding or engraving. A printed mark may also be employed. Without being limited to an arrow shape or a linear shape, any shape mark may be employed as long as directionality can be identified.

As another modification example, for example, if the detection axis of the inertial sensor is set in an extending direction of the groove portion and the fitting portion without disposing the direction indicator, the detection axis can be coincident with a predetermined direction by simply operating the base and the holding tool so as to be fitted to each other. Accordingly, it is possible to perform accurate motion detection. For example, if an angular speed sensor is used as the inertial sensor and the extending direction of the groove portion and the fitting portion is set to an axial direction, it is possible to accurately detect angular speed around the shaft axis. Accordingly, it is possible to accurately trace a change in a face angle of a golf club head.

According to the above-described motion detection device 100, the sensor 10 can be easily mounted on the holding tool 20 mounted on the golf club 200, by simply and slidingly fitting the sensor 10 to the holding tool 20 so that the fitting portions 20b and 20c included in the holding tool 20 are respectively inserted into the grooves 11d and 11e included in the sensor 10. Furthermore, since the sensor 10 is mounted on the holding tool 20, the grip rubber 200c included in the grip portion 200a is compressed and interposed between the mounting surface 20a of the holding tool 20 and the shaft portion 200b, thereby allowing the motion detection device 100 to have an improved holding force for holding the golf club 200. In this manner, a mounting position can be prevented from being misaligned due to an inertial force or an impact force which is applied to the motion detection device 100 by a swing of the golf club 200. Therefore, proper swing data of the golf club 200 can be obtained. In addition to the slidingly fitted structure, a method may be employed in which the base and the holding tool are pressed against and fitted to each other by using a structure where a recessed portion such as a groove portion or a hole portion is disposed in any one of the base and the holding tool, and where a projection-shaped portion such as the projection is disposed in the other one of the base and the holding tool.

The holding tool 20 according to the embodiment includes the curved plate 21 having the restraint portion 21a and the contact portion 22. Accordingly, when an external force is applied in a state where the holding tool 20 is mounted on an object such as the golf club 200, stress is dispersed, and stress concentration near the restraint portion 21a is relaxed. In this manner, the holding tool 20 in which dropping, misalignment, and rotating are less likely to occur can be stably mounted on the object. When the holding tool 20 is used in order to mount the sensor to the object, even if an impact is applied to the sensor 10 in a mounted state, the holding tool 20 is less likely to be damaged.

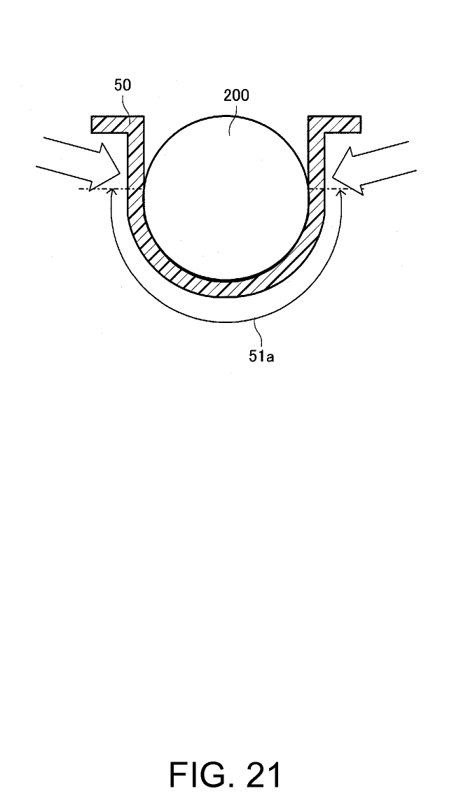

FIG. 21 is a schematic view illustrating an example of a cross section of a holding tool 50 in the related art. FIG. 21 corresponds to a cross section which is cut similarly to the cross sections illustrated in FIGS. 5A to 5D. As illustrated in FIG. 21, when the holding tool 50 in the related art is mounted on the golf club 200, all portions which come into contact with the golf club 200 serve as a restraint portion 51a for pressing the golf club 200. If a sensor is fitted to this holding tool 50 in the related art, stress is concentrated near both end portions of the restraint portion 51a illustrated by white arrows in the drawing. Therefore, if an unexpected external force (impact or vibrations) is applied to the golf club 200, a crack is likely to appear near both end portions of the holding tool 50.

In contrast, in the holding tool 20 according to the above-described embodiment, since the contact portion 22 is present, stress concentration around the restraint portion 21a is relaxed. In this manner, a crack is less likely to appear near both end portions of the holding tool 20. Since the non-contact portion 25 is present, stress can be further dispersed, and stress concentration near both end portions of the holding tool 20 can be further relaxed. Accordingly, damage can be further suppressed. In the holding tool 50 in the related art as illustrated in FIG. 21, when the holding tool 50 is mounted on the golf club 200, if the above-described elastic member 23 is installed on a surface on which the golf club 200 and the holding tool 50 come into contact with each other by means of adhering, the holding tool 50 comes to have the same configuration as the holding tool 20 according to the embodiment. Therefore, it will be appreciated that an aspect of the holding tool according to the invention is achieved.

### 1.5 Motion Detection Device

The motion detection device 100 according to the embodiment includes the above-described holding tool 20 and the sensor portion 13 included in the above-described sensor 10 fitted to the holding tool 20. According to this motion detection device 100, the sensor portion 13 in which dropping, misalignment, and rotating are less likely to occur can be stably mounted on an object such as the golf club 200. The motion detection device 100 according to the embodiment is less likely to be damaged even if an impact is applied in a state where the motion detection device 100 is mounted on the golf club 200.

The inner surface of the motion detection device 100 has the multiple restraint portions 21a which come into contact with the sports equipment by the inner surface being fastened to the sports equipment, and the discontinuous portion which causes the inner surface to function as the discontinuous surface by disposing at least any one of the concave portion and the convex portion therebetween. Alternatively, the motion detection device 100 includes the multiple restraint portions 21a which come into contact with the sports equipment by the inner surface being fastened to the sports equipment when the motion detection device 100 is mounted on and fastened to the sports equipment. The motion detection device 100 has a portion in which the inner surface does not extend along an outer shape of the sports equipment.

Therefore, when an external force is applied in a state where the motion detection device 100 is mounted on the sports equipment, stress is dispersed, and stress concentration is relaxed. In this manner, the motion detection device 100 in which dropping, misalignment, and rotating are less likely to occur can be stably mounted on the sports equipment. The motion detection device 100 is less likely to be damaged even if an impact is applied in a mounted state.

### 2. Sensor-Installed Sports Equipment

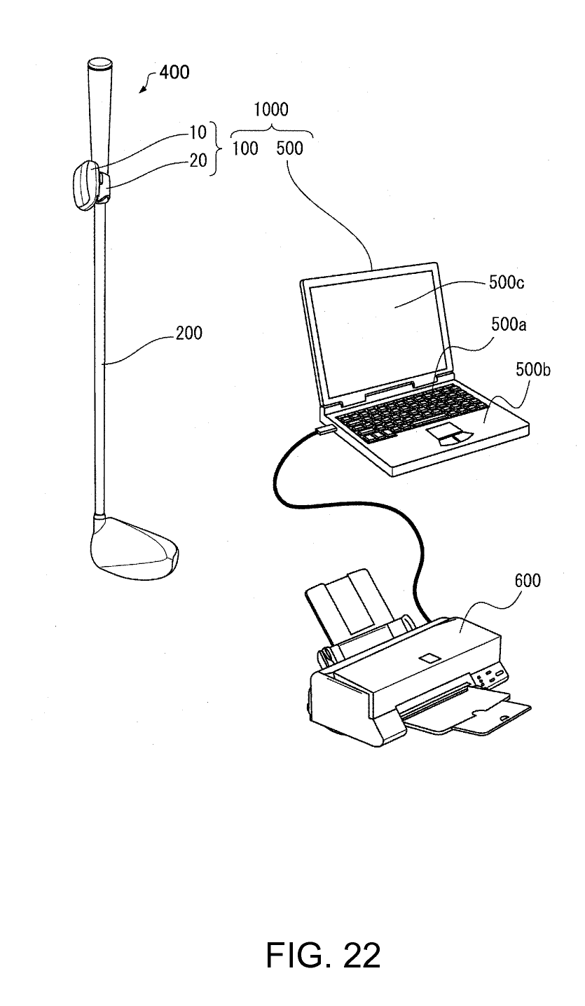

A sensor-installed sports equipment 400 according to the embodiment is a sports equipment such as the golf club 200, and the above-described motion detection device 100 is mounted thereon (refer to FIGS. 3 and 22). According to this sensor-installed sports equipment 400, a sensor portion in which dropping, misalignment, and rotating are less likely to occur can be stably mounted on the sensor-installed sports equipment. The motion detection device 100 is less likely to be damaged even if an impact is applied.

### 3. Motion Analysis Device

FIG. 22 is an external view illustrating a motion analysis device according to the embodiment. As illustrated in FIG. 22, a motion analysis device 1000 (hereinafter, referred to as an analysis device 1000) according to the embodiment includes the above-described motion detection device 100 and a computer 500 which analyzes motion data by acquiring the motion data which is obtained from the golf club 200 serving as an object by the motion detection device 100. The computer 500 includes a processing unit 500b provided with an input unit 500a, and a display unit 500c which displays a processing result. In the illustrated example, a personal computer 500 (hereinafter, referred to as a PC 500) is provided therein. However, a mobile terminal such as a tablet terminal or a smartphone may be properly connected thereto by wired or wireless communication. A printer 600 functioning as an external output may be further provided in order to record an analysis result of the PC 500. Although the embodiment will be described later, the embodiment adopts a configuration in which data is transmitted and received between the motion detection device 100 and the PC 500 by the wireless communication. However, without being limited thereto, the data may be transmitted and received therebetween via a recording medium by attaching the detachable recording medium such as an SD card and a USB memory, for example, to the motion detection device 100.

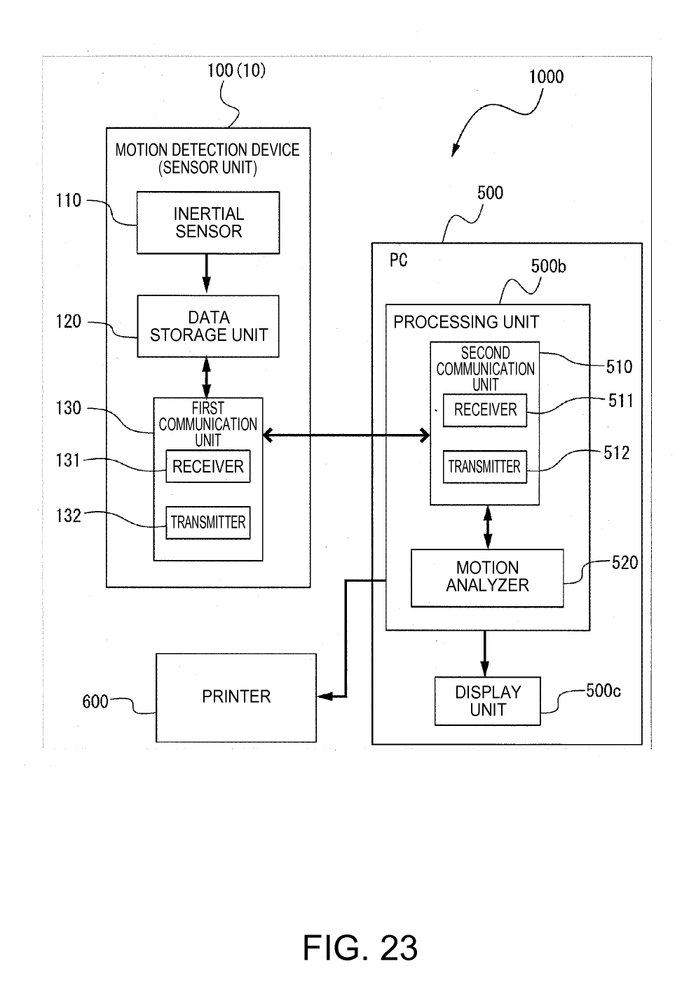

FIG. 23 illustrates a block diagram of the analysis device 1000 illustrated in FIG. 22. As illustrated in FIG. 23, the sensor 10 included in the motion detection device 100 includes at least, an inertial sensor 110, a data storage unit 120 which stores data while processing the data, and a first communication unit 130 including a transmitter 132 which transmits the data to the PC 500 and a receiver 131 which receives the data transmitted from the PC 500. The PC 500 functioning as an analysis device includes a second communication unit 510 including a receiver 511 which receives data transmitted from the first communication unit 130 of the motion detection device 100 and a transmitter 512 which transmits the data to the first communication unit 130, a processing unit 500b which includes a motion analyzer 520 for processing and analyzing the acquired detection data, and a display unit 500c which displays an analysis result obtained by the motion analyzer 520. The PC 500 further has the printer 600 functioning as an external output of the analysis result.

If a user swings the golf club 200 having the motion detection device 100 mounted thereon, the inertial sensor 110 detects an inertial force, and transmits detection data to the data storage unit 120. The data storage unit 120 processes the data into a data format which can be transmitted to the PC 500, and then stores (accumulates) the data until a transmission instruction is received from the PC 500. When a predetermined swing for the motion analysis is completed, work for the motion analysis starts. If the input unit 500a (not illustrated) commands the processing unit 500b to start analysis, an instruction to transmit the detection data is transmitted to the first communication unit 130 from the transmitter 512 of the second communication unit 510 by wireless communication. Based on the command received by the receiver 131 of the first communication unit 130, the detection data stored in the data storage unit 120 is transmitted to the processing unit 500b by the transmitter 132. The embodiment employs a form in which the first communication unit 130 and the second communication unit 510 are connected to each other by the wireless communication, but may be connected to each other by wired communication. As described above, the data may be transmitted and received therebetween via a recording medium by attaching the detachable recording medium to the motion detection device 100.

The detection data received by the receiver 511 of the second communication unit 510 is transmitted to the motion analyzer 520, and the motion analysis of the golf club 200 is performed, based on a predetermined analysis program. The analysis result is displayed as an image on the display unit 500c included in the PC 500. Alternatively, the analysis result is recorded on and output to a recording medium by the printer 600 functioning as the external output.

In the motion analysis device 1000 according to the embodiment, the motion detection device 100 can be easily attached to or detached from the illustrated object (golf club 200 in the embodiment). Therefore, for example, when characteristics of multiple objects are to be analyzed, at least one set of the motion detection device 100 may be prepared. Accordingly, costs for analysis can be reduced. In addition, a sensor is not mounted on an object by using adhesion means disclosed in the related art. Therefore, a period of time required for preparing the analysis can be shortened, and further the sensor is easily detached from the object after the analysis is completed. A period of time required for the analysis is shortened, and the object is prevented from becoming dirty due to an adhesive. Accordingly, without degrading a commodity value of the object, motion characteristics can be analyzed for the object.

Without being limited to the above-described embodiments, the invention may be further modified in various ways. For example, the invention includes configurations which are substantially the same as the configurations described in the embodiments (for example, the same configurations having the same function, method, and result, or the same configurations having the same object and advantageous effect). The invention includes configurations which replace non-essential elements of the configurations described in the embodiments. The invention includes configurations which can provide operation effects the same as those of the configurations described in the embodiments, or configurations which can achieve the same object. The invention includes configurations in which known techniques are added to the configurations described in the embodiments.

The entire disclosure of Japanese Patent Application No. 2014-229987, filed Nov. 12, 2014 is expressly incorporated by reference herein.

What is claimed is:

1. A motion detection device comprising:
a sensor that detects a motion; and
a holding tool that is used in order to mount the sensor on a sports equipment,
wherein the holding tool includes a curved plate whose one end is open, and which surrounds a portion of a shaft of the sports equipment when the holding tool is mounted on the sports equipment, and
wherein the curved plate has multiple restraint portions which come into contact with the shaft by an inner surface of the curved plate being fastened to the shaft when the curved plate is mounted on the sports equipment and the one end is fastened thereto, and a discontinuous portion which causes the inner surface to function as a discontinuous surface by disposing at least any one of a concave portion and a convex portion between the multiple restraint portions.

2. The motion detection device according to claim 1,
wherein when the curved plate is fastened, a non-contact portion in which the inner surface of the curved plate does not come into contact with the sports equipment is formed in the curved plate.

3. The motion detection device according to claim 1,
wherein the discontinuous portion is configured to include an elastic member which is disposed on the inner surface of the curved plate.

4. A motion detection device comprising:
a sensor that detects a motion; and
a holding tool that is used in order to mount the sensor on a sports equipment,
wherein the holding tool includes a curved plate whose one end is open, and which surrounds a portion of a shaft of the sports equipment when the holding tool is mounted on the sports equipment, and
wherein the curved plate includes multiple restraint portions which come into contact with the sports equipment by an inner surface of the curved plate being fastened to the sports equipment when the curved plate is mounted on the sports equipment and the one end is fastened thereto, and has a portion in which the inner surface does not extend along an outer shape of the sports equipment.

5. The motion detection device according to claim 1,
wherein the curved plate is connected to the sensor, in the one end.

6. The motion detection device according to claim 5,
wherein the holding tool is mounted on the sports equipment, and the sensor is fitted to the holding tool, in the one end, so as to fasten and fix the holding tool to the sports equipment.

7. A sports equipment on which the motion detection device according to claim 1 is mounted.

8. A sports equipment on which the motion detection device according to claim 4 is mounted.
